(19) United States
(12) Patent Application Publication
(10) Pub. No.: US 2022/0277545 A1
(43) Pub. Date: Sep. 1, 2022

(54) BINOCULAR IMAGE-BASED MODEL TRAINING METHOD AND APPARATUS, AND DATA PROCESSING DEVICE

(71) Applicant: GUANGZHOU HUYA TECHNOLOGY CO., LTD., Guangzhou (CN)

(72) Inventors: Pengpeng LIU, Guangzhou (CN); Jia XU, Guangzhou (CN)

(21) Appl. No.: 17/630,115

(22) PCT Filed: Jul. 27, 2020
(86) PCT No.: PCT/CN2020/104926

§ 371 Date: Jan. 25, 2022

(30) Foreign Application Priority Data
Aug. 15, 2019 (CN) 201910753808.X

(51) Int. Cl. G06V 10/74; G06V 10/774; G06V 10/77

(52) U.S. Cl. CPC G06V 10/761; G06V 10/774; G06V 10/7715

(57) ABSTRACT

A binocular image-based model training method and apparatus, and a data processing device are provided. An image matching model includes a teacher model and a student model. In the method, two groups of sample images acquired at different time points by a binocular image acquisition apparatus are first obtained; then, for any two sample images in the two groups of sample images, optical flow estimation is performed according to a preset geometric constraint between the two sample images by means of the teacher model, so as to obtain a more accurate high-confidence optical flow estimation result, the preset geometric constraint being a binocular image-based geometric constraint; and finally, machine learning training of image element matching is performed on the student model by using the two sample image, with the high-confidence optical flow estimation result taken as labeling information.

### CROSS-REFERENCE TO RELATED APPLICATION

The present disclosure claims the priority to the Chinese patent application filed with the Chinese Patent Office on Aug.15, 2019 with the filing No. 201910753808X, and entitled “Binocular Image-based Model Training Method and Apparatus, and Data Processing Device”, all the contents of which are incorporated herein by reference in entirety.

### Technical Field

The present disclosure relates to the technical field of computer vision, and specifically provides a method and an apparatus for model training based on binocular images (i.e. binocular image-based model training method and apparatus) as well as a data processing device.

### Background Art

In the field of computer vision identification, how to identify and match same object in different images is an extensively researched computer vision task, and it is a hot research project to obtain a Convolutional Neural Network (CNN) model capable of accurately performing optical flow estimation or binocular stereo matching.

In order to obtain an accurate image matching model, it is generally necessary to perform machine learning training on the image matching model, and usual training modes include supervised training methods and unsupervised training methods. Supervised training methods require a large number of labeled training image samples; however, if labeled real images are used as training samples, the training costs would generally be high, while the accuracy of identifying real images by the obtained model is poor, if emulational labeled images are used as training samples. In some unsupervised training methods, the training of a student model is guided by adopting optical flow estimation obtained by a teacher model, with the optical flow estimation as label, but the optical flow estimation based on the teacher model is not accurate enough, rendering that the identification capability of the student model might be affected.

### SUMMARY

An object of the present disclosure is to provide a method and an apparatus for model training based on binocular images, and a data processing device, which can realize self-supervised training using unlabeled images and enable relatively high identification accuracy of a model obtained through training.

In order to achieve at least one object among the above objects, following technical solutions are adopted in the present disclosure:

An embodiment of the present disclosure provides a binocular image-based model training method, which is applied to the training of an image matching model, with the image matching model comprising a teacher model and a student model, the method comprising:

obtaining two groups of sample images acquired by a binocular image acquisition apparatus at different time points;

performing, through the teacher model, optical flow estimation, directed at any two sample images in the two groups of sample images, according to a preset geometric constraint between the two sample images, so as to obtain an optical flow estimation result, here, the preset geometric constraint is a geometric constraint based on binocular images; and

performing, with the optical flow estimation result as labeling information, machine learning training of image element matching on the student model by using the two sample images, here, the process of the image element matching is of identifying image elements belonging to a same object in the two sample images.

An embodiment of the present disclosure further provides a binocular image-based model training apparatus, which is applied to the training of an image matching model, with the image matching model comprising a teacher model and a student model, the apparatus comprising:

an image obtaining module, configured to obtain two groups of sample images acquired by a binocular image acquisition apparatus at different time points;

a first training module, configured to perform, through the teacher model, optical flow estimation, directed at any two sample images in the two groups of sample images, according to a preset geometric constraint between the two sample images, so as to obtain an optical flow estimation result, here, the preset geometric constraint is a geometric constraint based on binocular images; and

a second training module, configured to perform, with the optical flow estimation result as labeling information, machine learning training of image element matching on the student model by using the two sample images, here, the process of the image element matching is of identifying image elements belonging to a same object in the two sample images.

An embodiment of the present disclosure further provides a data processing device, comprising a machine-readable storage medium and a processor, here, on the machine-readable storage medium, machine-executable instructions are stored, and a binocular image-based model training method as described above is implemented, when the machine-executable instructions are executed by the processor.

An embodiment of the present disclosure further provides a computer-readable storage medium, on which computer programs are stored, here, a binocular image-based model training method as described above is implemented, when the computer programs are executed by a processor.

### BRIEF DESCRIPTION OF DRAWINGS

FIG. 1 is a structural schematic view of a data processing device provided in an embodiment of the present disclosure;

FIG. 2 is a schematic flow chart of a binocular image-based model training method provided in an embodiment of the present disclosure;

FIG. 3 is a schematic view showing the relevance between binocular stereo matching and an optical flow provided in an embodiment of the present disclosure;

FIG. 4 is a schematic view showing the principle of a binocular image-based model training method provided in an embodiment of the present disclosure;

FIG. 5 is a schematic view of obtaining an optical flow diagram provided in an embodiment of the present disclosure;

FIG. 6 is a schematic view showing the geometric constraint of an optical flow diagram provided in an embodiment of the present disclosure;

FIG. 7 is a schematic view showing an optical flow estimation test result;

FIG. 8 is a schematic view showing a binocular stereo matching test result;

and

FIG. 9 is a schematic view of a binocular image-based model training apparatus provided in an embodiment of the present disclosure.

Reference signs: 100—-data processing device; 110—binocular image-based model training apparatus; 111—image obtaining module; 112—first training module; 113—second training module; 120—machine-readable storage medium; and 130—processor.

### DETAILED DESCRIPTION OF EMBODIMENTS

In order to make the objects, the technical solutions, and the advantages of the embodiments of the present disclosure clearer, the technical solutions in the embodiments of the present disclosure will be clearly and fully described below with reference to the accompanying drawings in the embodiments of the present disclosure. Clearly, the following described embodiments are partial embodiments of the present disclosure, but not all the embodiments. Generally, assemblies of the embodiments of the present disclosure, which are described and shown here in the drawings, could be arranged and designed in various different configurations.

Thus, following detailed description of the embodiments of the present disclosure that are provided in the drawings merely represents selected embodiments of the present disclosure, rather than being intended to limit the scope of the present disclosure for which protection is sought. All other embodiments, which could be obtained by a person ordinarily skilled in the art on the basis of the embodiments in the present disclosure without inventive effects, shall fall within the scope of protection of the present disclosure.

It should be noted that similar reference signs and letters represent similar items in the following drawings, thus, once a certain item is defined in one drawing, no further definition and explanation of this item is necessary in the subsequent drawings.

In some unsupervised training modes, an optical flow estimation mode is adopted as a teacher mode, a labeling result is obtained by performing optical flow estimation on training samples, this labeling result is then used for guiding the optical flow estimation training of another optical flow estimation model serving as a student model, here, an inaccurate optical flow estimation of the teacher model would directly cause a poor accuracy of the optical flow estimation of the trained student model.

Based on the discoveries about the above problems, a solution is provided in an embodiment of the present disclosure, in which binocular images are adopted as training samples, and a fixed geometric constraint of the binocular images is utilized for optical flow estimation, enabling the teacher model to obtain a more accurate optical flow estimation result, and further effectively improving the image matching accuracy of the student model. The solution provided in the embodiment of the present disclosure will be exemplarily illustrated below.

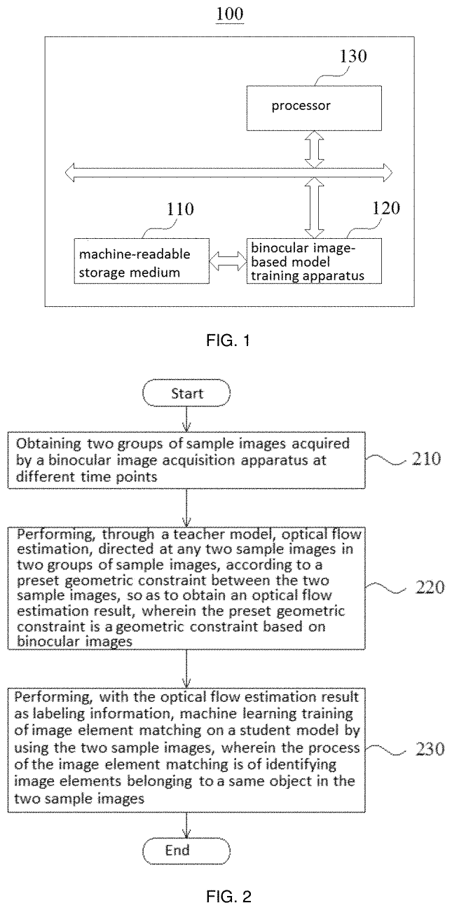

Referring to FIG. 1, FIG. 1 is a structural schematic view of a data processing device 100 provided in an embodiment of the present disclosure. In some possible embodiments, the data processing device 100 may comprise a binocular image-based model training apparatus 110, a machine-readable storage medium 120, and a processor 130.

Respective elements of the machine-readable storage medium 120 and the processor 130 may be in direct or indirect electrical connection with each other, so as to realize data transmission or interaction. For example, these elements could be in electrical connection with each other via one or more communication buses or signal lines. The binocular image-based model training apparatus 110 may include at least one software functional module, which could be stored in the machine-readable storage medium 120 in a form of software or firmware or be solidified in the operating system (OS) of the data processing device 100. The processor 130 may be configured to execute an executable module stored in the machine-readable storage medium 120, e.g. the software functional module included in the binocular image-based model training apparatus 110 and computer programs or the like.

In the above, the machine-readable storage medium 120 may be, but is not limited to, a Random Access Memory (RAM), a Read-Only Memory (ROM), a Programmable Read-Only Memory (PROM), an Erasable Programmable Read-Only Memory (EPROM), an Electric Erasable Programmable Read-Only Memory (EEPROM) or the like. In the above, the machine-readable storage medium 120 may be configured to store programs, and the processor 130 executes the programs after receiving an execution instruction.

Referring to FIG. 2, FIG. 2 is a schematic flow chart of a binocular image-based model training method, which is applied to the data processing device 100 as shown in FIG. 1, and respective steps included in the method will be exemplarily illustrated below.

Step 210: obtaining two groups of sample images acquired by a binocular image acquisition apparatus at different time points.

Step 220: performing, through the teacher model, optical flow estimation, directed at any two sample images in the two groups of sample images, according to a preset geometric constraint between the two sample images, so as to obtain an optical flow estimation result, here, the preset geometric constraint is a geometric constraint based on binocular images.

In some possible embodiments, binocular images are generally images taken by left and right cameras at the same time point on the same horizontal line but from different angles, so binocular images generally have 3D spatial geometric characteristics; thus, the above preset geometric constraint may be a geometric limitation of the optical flow between the sample images determined by utilizing the 3D spatial geometric characteristics of the binocular images.

Step 230: performing, with the optical flow estimation result as labeling information, machine learning training of image element matching on the student model by using the two sample images, here, the process of the image element matching is of identifying image elements belonging to a same object in the two sample images.

Optical flow is a technology of determining the motion of the same object in different frames of images according to the luminance, based on the assumption that the luminance of the same target in different images taken in a short period of time would not change and on the assumption that the object would not have significant position change in a short period of time.

Binocular stereo matching is a computer vision task capable of identifying the same object from images taken at the same time point from different angles.

It is discovered by the inventors through research that both images in the binocular image can be deemed as two images, here, a camera shoots at an angle to obtain one image and then immediately moves to another angle to shoot again to obtain the other image. Therefore, the binocular image matching can be regarded as a special case of optical flow estimation. Moreover, as for binocular images with corrected horizontal polar lines, the images generally have an inherent geometric constraint relationship therebewteen.

Thus, in step 210, the data processing device 100 can use images acquired by the binocular image acquisition device as training samples, and can enable the teacher model to obtain accurate optical flow estimation by utilizing the inherent geometric constraint of the binocular images.

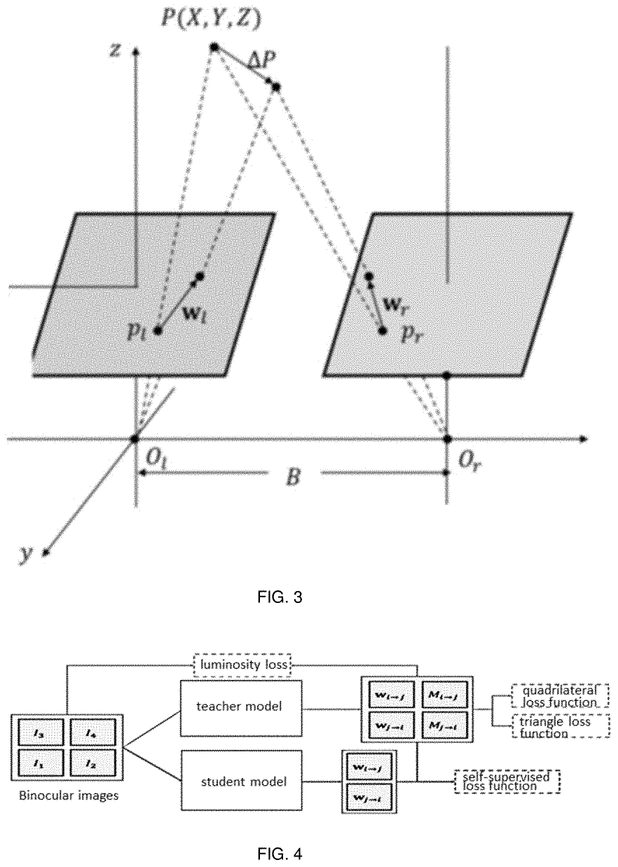

Exemplarily, referring to FIG. 3, a geometric relationship between the optical flow and the stereoscopic parallax in a 3D space is shown. In the above, Oₗ and Oᵣ respectively represent corrected center points of left and right cameras in the binocular image acquisition apparatus, B represents the distance between the centers of the two cameras, P(X,Y,Z) is a point in the 3D space at time point t, and Pₗ and Pᵣ respectively represent projection positions of the point P in the images acquired by the left and right cameras.

The point P moves to the position P+ΔP at time point t+1, and the displacement ΔP=(ΔX, ΔY, ΔZ) Optical flows wₗ and wᵣ respectively represent optical flows obtained in the pictures acquired by the left and right cameras before and after the movement of the point P, while the stereoscopic parallax represents simultaneously recorded displacement of a matching point between two binocular images. Despite of different definitions, optical flow estimation and binocular stereoscopic parallax can be deemed as a problem of the same type, that is, both belong to the matching of corresponding pixels.

During binocular stereo matching, the matching pixel shall be located in the polar line between the binocular image pair, while optical flow is not constrained by such a structure. Thus, in some embodiments, the binocular stereo matching may be deemed as a special case of optical flow. That is to say, the displacement between binocular images may be deemed as one-dimensional “movement”. For corrected binocular images, the polar line is horizontal, that is to say, the binocular stereo matching becomes search for matching pixels along a horizontal direction. Because of the inherent geometric constraint of binocular images, a relatively accurate optical flow estimation result can be obtained by performing optical flow estimation by utilizing binocular images.

In the above, it shall be clarified that a pixel point is occluded, if the pixel point is visible only in one frame of the images and invisible in another frame of the images. There may be many reasons for the pixel points being occluded, for example, movement of the object or movement of the camera or the like may all cause occluded pixel points. For instance, in some possible application scenarios, a certain object faces forwards in a first frame, the camera pictures the frontal part of this object, while in a second frame, the object turns to face backwards, then the camera can only capture the back part of the object, in this way, the frontal half part of the object in the first frame is invisible in the second frame, that is, being occluded.

In addition, since an occluded object generally does not conform to the assumption that the luminosity remains unchanged during the optical flow estimation, it would greatly affect the accuracy of the result outputted by the teacher model. In order to enable the teacher model to obtain more accurate optical flow estimation, as a possible embodiment, the data processing device 100 may, during the execution of step 220, perform optical flow estimation according to the preset geometric constraint and a confidence map by means of the teacher model, so as to obtain the optical flow estimation result with the occluded region excluded, here, the optical flow estimation result can indicate the displacement amount of an unoccluded pixel point between the two sample images, the confidence map can be determined according to the unoccluded region in the two sample images, and the confidence map can be used to indicate the occluded state of corresponding pixel points.

In this way, a confidence map obtained according to the luminosity difference is incorporated into the teacher model, so as to analyze the occluded region and obtain a confidence map, and a high-confidence optical flow diagram can be obtained by incorporating the confidence map, hereby improving the accuracy for guiding the student model in learning image matching.

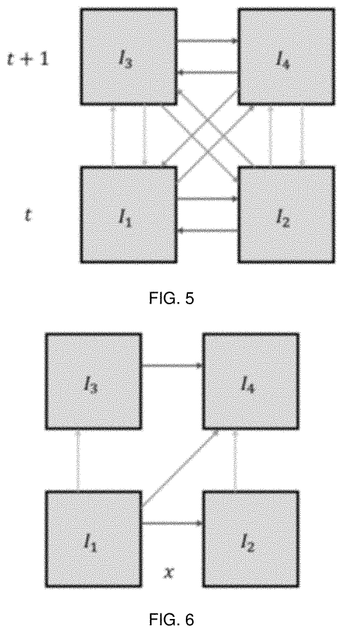

Exemplarily, referring to FIG. 4, FIG. 4 is a schematic view showing the principle of a binocular image-based model training method provided in the present embodiment. In the two groups of sample images obtained by the data processing device 100 through step 210, each group of sample images may contain two sample images. For example, in combination with what is shown in FIG. 5, it is assumed that images respectively acquired by the left and right cameras in the binocular image acquisition apparatus at the time point t are marked as I₁ and I₂, and images respectively acquired by the left and right cameras in the binocular image acquisition apparatus at the time point t+1 are marked as I₃ and I₄.

In step 220, the data processing device 100 can arbitrarily select two sample images from the above four images, and firstly calculate and obtain an initial optical flow diagram of the two sample images according to the preset geometric constraint, here, the initial optical flow diagram can indicate the displacement amount of corresponding pixel point between the two sample images.

As shown in FIG. 5, 12 optical flow diagrams can be obtained among the four sample images obtained by the data processing device 100 by executing step 210, and in some embodiments, the optical flow diagram from image Iᵢ to image Iⱼ is marked as w_{i→j}.

Then, the data processing device 100 can perform forward-backward luminance detection on the initial optical flow diagram, here, pixels with a luminance difference exceeding a preset range are taken as occluded pixels, of which the confidence is set to 0, while pixels with a luminance difference not exceeding the preset range are taken as unoccluded pixels, of which the confidence is set to 1. Since the confidence of the occluded pixels in the confidence map is set to 0, the occluded pixels are excluded by multiplying the optical flow diagram by the confidence map, and accordingly, the obtained optical flow diagram only includes unoccluded high-confidence regions.

In addition, while executing the forward-backward detection, the data processing device 100 can firstly obtain a forward optical flow w_{i→j}(p) of a pixel p on the initial optical flow diagram from image Iᵢ to image Iⱼ in the two samples, and obtain a backward optical flow ŵ_{j→i}(p) from the image Iⱼ to the image Iᵢ, and ŵ_{j→i}(p)=w_{j→i}(p+w_{i→j}(p)).

Then, it is detected whether the forward optical flow w_{i→j}(p) and the backward optical flow ŵ_{j→i}(p) meet the following condition:

|w_{i→j}(p)+wj→ip2<αwi→jp2+wj→ip2+β, and α=0.001, β=1.05

If the condition is met, it means that the luminosity difference of the pixel p is within the preset range, that is, the pixel P lies in an unoccluded region, and the data processing device 100 accordingly sets the confidence of the pixel p to 1.

If the condition is not met, it means that the luminosity difference of the pixel P exceeds the preset range, that is, the pixel p lies in an occluded region, and the data processing device 100 accordingly sets the confidence of the pixel p to 0.

After obtaining the confidence map, the data processing device 100 can perform optical flow estimation on the two sample images according to the preset geometric constraint and the confidence map, so as to obtain the optical flow estimation result.

In some possible embodiments, the preset geometric constraint may include a triangle constraint and a quadrilateral constraint, for example, optical flow estimation can be performed on the two sample images through a luminosity loss function Lₚ, a quadrilateral loss function L_{q} determined according to the quadrilateral constraint, a triangle loss function Lᵢ determined according to the triangle constraint, and the confidence map. Exemplarily, according to the inherent characteristics of the binocular images, the four images obtained by the data processing device 100 through step 210 generally have several fixed constraints. It is assumed that Pₜ^{l} represents a pixel in the image I₁, and pₜ^{r}, pₜ₊₁^{l}, and pₜ₊₁^{r} respectively represent pixels in the images I₂, I₃, and I₄. Referring to FIG. 6, taking the image I₁ as reference for example, 3_{1→2} and w_{3→4} can be selected to represent stereoscopic parallax, s_{1→3} and w_{2→4} are selected to represent optical flows at different time points, and w_{1→4} is selected to represent transparallax optical flow. Following equations are obtained accordingly:

$$\{ \begin{matrix}{p}_{t}^{r} = {p}_{t}^{l} + {w}_{1 \to 2} ( {p}_{t}^{l} ) \\ {p}_{t + 1}^{l} = {p}_{t}^{l} + {w}_{1 \to 3} ( {p}_{t}^{l} ) \\ {p}_{t + 1}^{r} = {p}_{t}^{l} + {w}_{1 \to 4} ( {p}_{t}^{l} )\end{matrix}$$

Since the movement of a certain object from a position in the image I₁ to a position in the image I₄ is equivalent to the movement from the position in the image I₁to a position in the image I₂ and then from the position in the image I₂ to the position in the image I₄, then following equation is obtained:

w_{1→4}(pₜ^{l})=pₜ₊₁^{r}−pₜ^{l}=(pₜ₊₁^{r}−pₜ^{r})+(pₜ^{r}−pₜ^{l})=w_{2→4}(pₜ^{r})+w_{1→2}(pₜ^{l})

Correspondingly, based on the movement of the object from the position in the image I₁ to a position in the image I₃ and then from the position in the image I₃ to the position in the image I₄, following equation could be obtained:

w_{1→4}(pₜ^{l})=pₜ₊₁^{r}−pₜ^{l}=(pₜ₊₁^{r}−pₜ₊₁^{r})+(pₜ₊₁^{r}−pₜ^{l})=w_{3→4}(pₜ₊₁^{l})+w_{1→3}(pₜ^{l})

According to the above two equations, following equation could be obtained:

w_{2→4}(pₜ^{r})−w_{1→3}(pₜ^{l})=w_{3→4}(pₜ₊₁^{l})−w_{1→2}(pₜ^{l})

Yet since during the processing of the binocular stereo matching task, matching pixels are generally located at the same polar line and the polar line in corrected binocular images is horizontal, following equation can be obtained in combination with the above equations:

$$\{ \begin{matrix}{u}_{2 \to 4} ( {p}_{t}^{r} ) - {u}_{1 \to 4} ( {p}_{t}^{l} ) = {u}_{3 \to 4} ( {p}_{t + 1}^{l} ) - {u}_{1 \to 2} ( {p}_{t}^{l} ) \\ {v}_{2 \to 4} ( {p}_{t}^{r} ) - {v}_{1 \to 4} ( {p}_{t}^{l} ) = 0\end{matrix}$$

here, u_{i→j} represents an optical flow in a horizontal direction from the image Iᵢ to the image Iⱼ, and v_{i→j} represents an optical flow in a vertical direction from the image to the image Iᵢ to the image Iⱼ,

Directed at the pixel point p, the luminosity loss function Lₚ is read as follows:

$${L}_{p} = {\sum }_{i , j} \frac{{\sum }_{p} ψ ( {I}_{i} ( p ) - {I}_{j \to i}^{ω} ( p ) ) ⊙ {M}_{i \to j} ( p )}{{\sum }_{p} {M}_{i \to j} ( p )}$$

here, I_{j→i}^{ω} represents a warp image obtained by warping the image Iⱼ to the image Iᵢ according to the optical flow 3_{i→i} from the image Iᵢto the image Iⱼ in the two samples, M_{i→j} is a confidence map from the image Iᵢ to the image Iⱼ, Ψ(x)=(|x|+s)^{q}, s=0.01, q=0.4.

The quadrilateral constraint is configured to define the geometric relationship between the optical flow and the stereoscopic parallax; in some embodiments, the quadrilateral constraint may only be applied to high-confidence pixels, which represent unoccluded regions in the images. In the quadrilateral loss function L_{q}=L_{qu}+L_{qv}, L_{qu} represents a component of the quadrilateral loss function L_{q} in the horizontal direction, and L_{qv} represents a component of the quadrilateral loss function L_{q} in the vertical direction, here,

$${L}_{qu} = {\sum }_{{p}_{t}^{l}} ψ ( {u}_{1 \to 2} ( {p}_{t}^{l} ) + {u}_{2 \to 4} ( {p}_{t}^{l} ) + {u}_{1 \to 3} ( {p}_{t}^{l} ) - {u}_{3 \to 4} ( {p}_{t + 1}^{l} ) ) ⊙ {M}_{q} ( {p}_{t}^{l} ) \text{/} {\sum }_{{p}_{t}^{l}} {M}_{q} ( {p}_{t}^{l} ) , \\ {L}_{qv} = {\sum }_{{p}_{t}^{l}} ψ ( {v}_{2 \to 4} ( {p}_{t}^{r} ) - {v}_{1 \to 3} ( {p}_{t}^{l} ) ) ⊙ {M}_{q} ( {p}_{t}^{l} ) \text{/} {\sum }_{{p}_{t}^{l}} {M}_{q} ( {p}_{t}^{l} ) ,$$

pₜ^{l}, pₜ^{r}, p₊₁^{l}, and Pₜ₊₁^{r} respectively represent pixels of the images I₁, I₂, I₃, and I₄ at the same position, and I₁ and I₂ are binocular images acquired at the time point t, I₃ and I₄ are binocular images acquired at the time point t+1, M_{q}=M_{1→2}(p) ⊙ M_{1→3}(p) ⊙ M_{1→4}(p).

The triangle constraint can be configured to define the relationships between the optical flow, the stereoscopic parallax, and the transparallax optical flow. Similar to the quadrilateral constraint loss, in some embodiments, the triangle constraint may only be applied to high-confidence pixels. The triangle loss function Lₜ is read as follows:

$${L}_{t} = {\sum }_{i , j} ψ ( {w}_{1 \to 4} ( {p}_{t}^{l} ) - {w}_{2 \to 4} ( {p}_{t}^{r} ) - {w}_{1 \to 2} ( {p}_{t}^{l} ) ) ⊙ {M}_{t} ( p ) \text{/} {\sum }_{{p}_{t}^{l}} {M}_{t} ( {p}_{t}^{l} )$$

here, pₜ^{l} and pₜ^{r} are respectively pixels of the images I₁ and I₂ at the same position, w_{1→4} represents an optical flow from the image I₁ to the image I₄, w_{2→4} represents an optical flow from the image I₂ to the image I₄, w_{1→2} represents an optical flow from the image I₁ to the image I₂, I₁ and I₂ are binocular images acquired at the time point t, I₃ and I₄ are binocular images acquired at the time point t+1.

After obtaining the high-confidence optical flow estimation result by executing step 220, the data processing device 100 can take the optical flow estimation result as labeling information by executing step 230, and train the student model through the two sample images obtained in step 220.

During the training process of the student model, a preset self-supervised loss function Lₛ can be used. As for the student model, the data processing device 100 can mark as \tilde{w}_{i→j} a representative optical flow in the high-confidence optical flow estimation result obtained in step 220 and mark a representative confidence map as \tilde{M}_{i→j} then following equation can be obtained:

$${L}_{s} = {\sum }_{i . k} \frac{{\sum }_{p} ψ ( {\tilde{w}}_{i \to j} ( p ) - {w}_{i \to j} ( p ) ) ⊙ {\tilde{M}}_{i \to j} ( p )}{{\sum }_{p} {\tilde{M}}_{i \to j} ( p )}$$

here, w_{i→j} represents an optical flow obtained by the student model.

It is to be clarified that in some embodiments, differing from the training of the teacher model, it is also possible not to distinguish occluded regions from unoccluded regions during the self-supervised training of the student model, and the student model can accordingly be enabled to estimate the optical flow in the occluded regions.

By adopting the method provided in the embodiments of the present disclosure, during the training process, the teacher model can be configured to obtain the optical flow of partial high-confidence pixel points from inputted sample images, as labeling information, and the student model performs optical flow estimation training directed at all pixel points in the image according to the labeling information obtained by the teacher model.

Therefore, in the embodiments of the present disclosure, after the completion of the training of the image matching model, the student model can be used to execute optical flow estimation or binocular image matching. During the use, two images to be processed can be obtained, the two images to be processed are then inputted into the well-trained student model, and an image matching result outputted by the student model directed at the two images to be processed is obtained.

When the well-trained student model is configured to perform optical flow estimation, two images acquired at different time points can be inputted into the student model, which can output an optical flow diagram between the two images. When the well-trained student model is configured to perform binocular image matching, images acquired by the left and right cameras in the binocular image can be inputted into the student model, which outputs a stereoscopic parallax diagram of the two images.

Optionally, in order to improve the identification capability of the student model, in some possible embodiments, the two sample images can be firstly subjected to identical random trimming, and the two trimmed sample images are used to perform machine learning training of image element matching on the student model. Moreover, in some possible embodiments, during the training of the student model, the two sample images can also be subjected to identical random scaling and rotation, in this way, over-fitting during the training process can be avoided.

In some embodiments, the image matching model can be constructed by using TensorFlow system with Adam optimizer. As for the teacher model, batch parameter can be set to 1, because there are 12 optical flow estimations among four images. As for the student model, the batch parameter can be set to 4, and some data enhancement strategies can be adopted simultaneously. During the training, an image having a resolution of 320*896 can be set as input. During the test, the resolution of the image may be regulated to 384*1280.

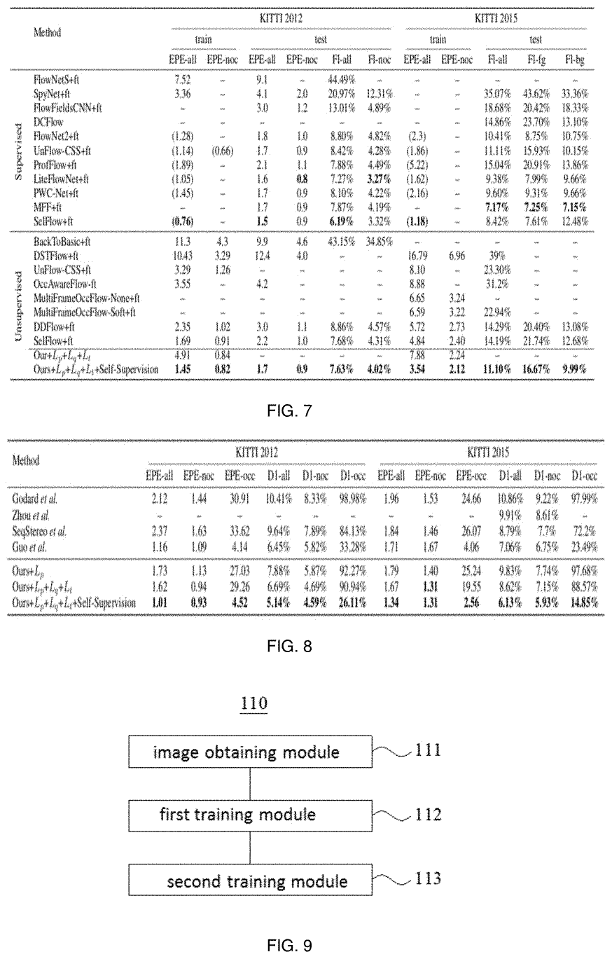

FIG. 7 shows test results of optical flow estimations performed on KITTI 2012 and KITTI 2015 data sets by some other models and the image matching model trained according to the embodiments of the present disclosure, here, ‘fg’ and ‘bg’ can respectively represent the results of foreground color and background color regions. In FIG. 7, the item “Ours+Lₚ+L_{q}+Lₜ+Self-supervision” can represent optical flow estimation test data of the image matching model trained by utilizing the solution provided in the embodiments of the present disclosure, and it can be seen that the identification capability of this image matching model is higher than that of other models in FIG. 7.

FIG. 8 shows test results of binocular stereo matching performed on KITTI 2012 and KITTI 2015 data sets by some other models and the image matching model trained according to the embodiments of the present disclosure. In FIG. 8, the item “Ours+Lₚ+L_{q}+Lₜ+Self-supervision” can represent binocular stereo matching test data of the image matching model trained by utilizing the solution provided in the embodiments of the present disclosure, and it can be seen that the identification capability of this image matching model is significantly higher than that of other models in FIG. 7.

Referring to FIG. 9, the present embodiment further provides a binocular image-based model training apparatus 110, this apparatus can comprise an image obtaining module 111, a first training module 112, and a second training module 113.

The image obtaining module 111 is configured to obtain two groups of sample images acquired by a binocular image acquisition apparatus at different time points.

In the present embodiment, the image obtaining module 111 can be configured to execute step 210 shown in FIG. 2, and as for specific description of the image obtaining module 111, reference can be made to the description of step 210.

The first training module 112 is configured to perform through the teacher model optical flow estimation, directed at any two sample images in the two groups of sample images, according to a preset geometric constraint between the two sample images, so as to obtain an optical flow estimation result, here, the preset geometric constraint is a geometric constraint based on binocular images.

In the present embodiment, the first training module 112 can be configured to execute step 220 shown in FIG. 2, and as for specific description of the first training module 112, reference can be made to the description of step 220.

The second training module 113 is configured to perform, with the optical flow estimation result as labeling information, machine learning training of image element matching on the student model by using the two sample images, and the process of the image element matching is of identifying image elements belonging to a same object in the two sample images.

In the present embodiment, the second training module 113 can be configured to execute step 230 shown in FIG. 2, and as for specific description of the second training module 113, reference can be made to the description of step 230.

In summary, as for the binocular image-based model training method and apparatus as well as the data processing device, which are provided in the present disclosure, the teacher model is enabled to output a high-confidence optical flow estimation result for guiding the student model in image matching learning, by using binocular images as training samples and by incorporating the inherent geometric constraints of the binocular images. In this way, self-supervised training using unlabeled images can be realized, and a model obtained through training has relatively high identification accuracy.

In the embodiments provided in the present disclosure, it should be understood that the disclosed apparatus and method may also be implemented in other ways. The apparatus embodiments described above are merely illustrative, for example, the flow charts and the block diagrams in the accompanying drawings show possibly implementable system architecture, functions, and operations of the apparatus, the method, and computer program product according to some embodiments of the present disclosure. In this regard, each block in the flow charts or the block diagrams may represent one module, a program segment, or a part of code, with the module, the program segment, or the part of code containing one or more executable instructions used to realize prescribed logical functions.

It shall also be noted that in some implementation modes as alternatives, functions marked in the blocks may also occur in an order differing from that marked in the accompanying drawings. For example, two sequential blocks can practically be executed substantially in parallel (at the same time), or they may also be executed in a reverse order, which depends on relevant functions.

It is also to be noted that each block in the block diagrams and/or flow charts and combinations of blocks in the block diagrams and/or flow charts can be implemented by a dedicated hardware-based system for executing a prescribed function or action, or can be implemented through a combination of dedicated hardware and computer instructions.

In addition, respective functional modules in some embodiments of the present disclosure may be integrated together to form an independent part, or respective modules may also exist separately, or two or more modules may also be integrated to form an independent part.

If the function is implemented in a form of a software functional module and is sold or used as an independent product, the function can be stored in a computer-readable storage medium. On the basis of such understanding, the technical solution of the present disclosure essentially or a part contributive to the prior art, or a part of the technical solution can be embodied in a form of a software product, and the computer software product is stored in a storage medium, including several instructions to enable a computer device (which may be a personal computer, a server, or a network device or the like) to execute all or partial steps of the method according to some embodiments of the present disclosure. Moreover, the preceding storage medium includes various media being capable of storing program codes, such as USB flash disk, mobile hard disk, Read-Only Memory, Random Access Memory, magnetic disk or optical disk.

The above mentioned are merely some exemplary embodiments of the present disclosure; however, the scope of protection of the present disclosure is not limited thereto, and any technician familiar with this technical field can readily think of variations or substitutions within the technical scope disclosed in the present disclosure, and these variations and substitutions shall all be covered in the scope of protection of the present disclosure. Thus, the scope of protection of the present disclosure shall be defined according to the scope claimed by the claims.

### INDUSTRIAL APPLICABILITY

The teacher model is enabled to output a high-confidence optical flow estimation result for guiding the student model in image matching learning, by using binocular images as training samples and by incorporating the inherent geometric constraints of the binocular images. In this way, self-supervised training using unlabeled images can be realized, and a model obtained through training has relatively high identification accuracy.

1. A binocular image-based model training method, applicable to training of an image matching model, with the image matching model comprising a teacher model and a student model, wherein the method comprises steps of:
obtaining two groups of sample images acquired by a binocular image acquisition apparatus at different time points;
performing, through the teacher model, optical flow estimation, directed at any two sample images in the two groups of sample images, according to a preset geometric constraint between the two sample images, so as to obtain an optical flow estimation result, wherein the preset geometric constraint is a geometric constraint based on binocular images;
performing, with the optical flow estimation result as labeling information, machine learning training of image element matching on the student model by using the two sample images, wherein a process of the image element matching is of identifying image elements belonging to a same object in the two sample images.

2. The method according to claim 1, further comprising steps of:
obtaining two images to be processed;
inputting the two images to be processed into the trained student model, so as to obtain an image matching result outputted by the student model directed at the two images to be processed.

3. The method according to claim 1, wherein the step of performing through the teacher model optical flow estimation according to a preset geometric constraint between the two sample images comprises steps of:
performing through the teacher model optical flow estimation according to the preset geometric constraint and a confidence map, so as to obtain the optical flow estimation result with an occluded region excluded, wherein the confidence map is determined by an unoccluded region in the two sample images.

4. The method according to claim 3, wherein the step of performing optical flow estimation according to the preset geometric constraint and a confidence map comprises steps of:
calculating and obtaining an initial optical flow diagram of the two sample images according to the preset geometric constraint;
performing forward-backward luminance detection on the initial optical flow diagram, wherein pixels with a luminance difference exceeding a preset range are taken as occluded pixels, of which the confidence is set to 0, while pixels with a luminance difference not exceeding the preset range are taken as unoccluded pixels, of which the confidence is set to 1;
performing optical flow estimation on the two sample images according to the preset geometric constraint and the confidence map, so as to obtain the optical flow estimation result.

5. The method according to claim 4, wherein the step of performing forward-backward luminance detection on the initial optical flow diagram comprises:
obtaining a forward optical flow w₋ⱼ(p) of a pixel p on the initial optical flow diagram from image Iᵢ to image Iⱼ in the two samples, and obtaining a backward optical flow ŵ_{4→i}(p) from the image Iⱼ to the image Iᵢ, wherein ŵ_{j→i}(p)=w_{j→i}, (p+w_{i→j}(p));
detecting whether the forward optical flow w_{i→j}(p) and the backward optical flow ŵ_{j→i}(p) meet a following condition: |w_{i→j}(p)+wj→ip2<αwi→jp2+wj→ip2+β, wherein α=0.01, β=0.5,
setting a confidence of the pixel p to 1, if the condition is met; or
setting the confidence of the pixel p to 0, if the condition is not met.

6. The method according to claim 3, wherein the preset geometric constraint comprises a triangle constraint and a quadrilateral constraint; and the step of performing optical flow estimation according to the preset geometric constraint and a confidence map comprises:
performing optical flow estimation on the two sample images through a luminosity loss function Lₚ, a quadrilateral loss function L_{q} determined according to the quadrilateral constraint, a triangle loss function Lₜ determined according to the triangle constraint, and the confidence map.

7. The method according to claim 6, wherein for the pixel point p, the luminosity loss function Lₚ is read as follows:
$${L}_{p} = {\sum }_{i , j} \frac{{\sum }_{p} ψ ( {I}_{i} ( p ) - {I}_{j \to i}^{ω} ( p ) ) ⊙ {M}_{i \to j} ( p )}{{\sum }_{p} {M}_{i \to j} ( p )}$$
wherein I_{j→i}^{ω} represents a warp image obtained by warping the image Iⱼ to the image Iᵢ according to the optical flow w_{i→j} from the image Iᵢ to the image Iⱼ in the two samples,
M_{i→j} is a confidence map from the image Iᵢ to the image Iⱼ, and
Ψ(x)=(|x|+s)^{q}, s=0.01, q=0.4.

8. The method according to claim 7, wherein the quadrilateral loss function L_{q}=L_{qu}+L_{qv}, L_{qu}, represents a component of the quadrilateral loss function L_{q} in a horizontal direction, and L_{qv}, represents a component of the quadrilateral loss function L_{q} in a vertical direction, wherein
L_{qu}Σₚ_{ₜ}Ψ(u_{1→2}(pₜ^{l})+u_{2→4}(pₜ^{l})+u_{1→3}(pₜ^{l})−u_{3→4}(pₜ₊₁^{l})) ⊙ M_{q}(pₜ^{l})/ Σₚ_{ₜ}_{^{l}} M_{q}(pₜ^{l}),
L_{qv}=Σₚ_{ₜ}_{^{l}} Ψ(v_{2→4}(pₜ^{r})−v_{1→3}(pₜ^{l}) ⊙ M_{q}(pₜ^{l})/Σₚ_{ₜ}_{^{l}} M_{q}(pₜ^{l}),
pₜ^{l}, pₜ^{r}, pₜ₊₁, and p₁₊₁^{r} respectively represent pixels of images I₁, I₂, I₃, and I₄ at the same position, I₁ and I₂ are binocular images acquired at a time point t, I₃ and I₄ are binocular images acquired at a time point t+1, u represents an optical flow in the horizontal direction, and v represents an optical flow in the vertical direction,
Ψ(x)=(|x|+s)^{q}, s=0.01, q=0.4, and
M_{q}=M_{1→2}(p) ⊙ M_{1→3}(p) ⊙ M_{1→4}(p), with M_{i→j} representing the confidence map from the image Iᵢ to the image Iᵢ.

9. The method according to claim 7, wherein the triangle loss function Lₜ is read as follows:
$${L}_{t} {\sum }_{i , j} ψ ( {w}_{1 \to 4} ( {p}_{t}^{l} ) - {w}_{2 \to 4} ( {p}_{t}^{r} ) - {w}_{1 \to 2} ( {p}_{t}^{l} ) ) ⊙ {M}_{t} ( p ) \text{/} {\sum }_{{p}_{t}^{l}} {M}_{t} ( {p}_{t}^{l} )$$
wherein pₜ^{l} and pₜ^{r} are respectively pixels of the images I₁ and I₂ at the same position, w_{1→4} represents an optical flow from the image I₁ to the image I₄, w_{2→4} represents an optical flow from the image I₂ to the image I₄, 3_{1→2} represents an optical flow from the image I₁ to the image I₂, I₁ and I₂ are binocular images acquired at the time point t, I₃ and I/₄ are binocular images acquired at the time point t+1,
M_{i→j} represents a confidence map from the image Iᵢ to the image Iⱼ, and Ψ(x)=(|x|+s)^{q}, s=0.01, q=0.4.

10. The method according to claim 6, wherein both the triangle constraint and the quadrilateral constraint are used to perform optical flow estimation directed at a corresponding high-confidence pixel in the image; wherein the corresponding high-confidence pixel is an unoccluded region in the image.

11. The method according to claim 3, wherein as for the student model, the optical flow estimation result comprises a representative optical flow \tilde{w}_{i→j} and a representative confidence map \tilde{M}_{i→j} outputted by the teacher model; and the step of performing with the optical flow estimation result as labeling information machine learning training of image element matching on the student model by using the two sample images comprises:
performing machine learning training of image element matching on the student model according to a self-supervised loss function Lₛ by using the two sample images, wherein
$${L}_{s} = {\sum }_{i , j} \frac{{\sum }_{p} ψ ( {\tilde{w}}_{i \to j} ( p ) - {w}_{i \to j} ( p ) ) ⊙ {\tilde{M}}_{i \to j} ( p )}{{\sum }_{p} {\tilde{M}}_{i \to j} ( p )}$$
p represents a pixel point from the image Iᵢ to the image Iⱼ in the two samples, w_{i→j} represents an optical flow obtained by the student model, Ψ(x)=(|x|+s)^{q}, s=0.01, q=0.4.

12. The method according to claim 1, wherein the step of performing with the optical flow estimation result as labeling information machine learning training of image element matching on the student model by using the two sample images comprises:
performing identical random trimming on the two sample images;
performing machine learning training of image element matching on the student model by using the two trimmed sample images, with the optical flow estimation result taken as labeling information.

13. A binocular image-based model training apparatus, applicable to training of an image matching model, with the image matching model comprising a teacher model and a student model, wherein the apparatus comprises:
an image obtaining module, configured to obtain two groups of sample images acquired by a binocular image acquisition apparatus at different time points;
a first training module, configured to perform through the teacher model optical flow estimation, directed at any two sample images in the two groups of sample images, according to a preset geometric constraint between the two sample images, so as to obtain an optical flow estimation result, wherein the preset geometric constraint is a geometric constraint based on binocular images; and
a second training module, configured to perform, with the optical flow estimation result as labeling information, machine learning training of image element matching on the student model by using the two sample images, wherein a process of the image element matching is of identifying image elements belonging to a same object in the two sample images.

14. (canceled)

15. A computer-readable storage medium, on which computer programs are stored, wherein the method according to claim 1 is implemented, when the computer programs are executed by a processor.
